(19) United States
(12) Patent Application Publication
(10) Pub. No.: US 2024/0217131 A1
(43) Pub. Date: Jul. 4, 2024

(54) HAIR CLIPPERS

(71) Applicant: Sunbeam Products, Inc., Atlanta, GA (US)

(72) Inventors: Jeff LePori, Hattiesburg, MS (US); Russell Goodman, Pelham, TN (US); George Hardin, Hattiesburg, MS (US)

(21) Appl. No.: 18/560,139

(22) PCT Filed: May 16, 2022
(86) PCT No.: PCT/US22/72355

§ 371 Date: Nov. 10, 2023

Related U.S. Application Data
(60) Provisional application No. 63/188,748, filed on May 14, 2021.

(51) Int. Cl. B26B 19/38

(52) U.S. Cl. CPC B26B 19/388

(57) ABSTRACT

Hair clippers are provided that include a controller and one or more sensors to control operating parameters of the hair clippers, thus enabling recording of the operating parameter values, increased battery life and usage time of the clippers, reduced battery charging time, better blade speed control, and overheating protection for the motor and blades. In some embodiments, the hair clippers include a communication and/or power connection, thus enabling the operating parameters to be changed, controlled, and/or downloaded from and/or to a computing device.

### CROSS-REFERENCE TO RELATED APPLICATION

This application claims the benefit of the filing date of U.S. Provisional Application No. 63/188,748 filed May 14, 2021, entitled HAIR CLIPPERS, which is hereby incorporated by reference as if fully set forth herein.

### FIELD

The disclosure relates to cutting tools, and more particularly to hair clippers that dynamically control operating parameters of the clippers.

### BACKGROUND OF THE INVENTION

Electric hair clippers have long been used by hair professionals and individuals that cut their hair at home. Such hair clippers work on the same principle as scissors, but require less manual labor. Hair clippers typically include a motor, a battery, and blades. One such blade generally reciprocates relative to the other. Unlike a shaver that is designed to completely remove hair thus having no visible hair a shave, a clipper generally merely trims the hair, thus having some length of hair leftover after clipping.

One example drawback of such reciprocating blade hair clippers is vibration. The reciprocation of a cutting blade is generally caused by an eccentric that is inherently unevenly weighted. Movement of the eccentric and the cutting blade thereby naturally cause some vibration. Further, the motor in most hair clippers continues to drive the blade(s) during times when hair is not being cut. This depletes the battery more quickly and leads to increased heat generation, noise, and vibration by the motor and blades.

### BRIEF DESCRIPTION OF THE INVENTION

The hair clippers hereof improve upon those that have been employed by barbers and self-haircutters, such as those described above. More particularly, the improved hair clippers hereof include a controller (e.g., microprocessor, etc.), such as one mounted on a printed circuit board assembly (PCBA), and one or more sensors to control operating parameters (e.g., speed, current, voltage, etc.) of the hair clippers battery, motor, and blades. In some embodiments, the improved hair clippers hereof include a communication and/or power connection (e.g., a universal serial bus (USB) interface, etc.) that enables the operating parameters to be changed, controlled, and/or downloaded from and/or to a computing device (e.g., a personal computer (PC), etc.).

### BRIEF DESCRIPTION OF THE DRAWINGS

FIG. 1 illustrates a block diagram of a hair clippers including a controller, one or more sensors, and a communication and/or power connection according to an exemplary embodiment;

FIG. 2 illustrates an exemplary block diagram of a method of operation of the hair clippers of FIG. 1;

FIG. 3 illustrates an exemplary block diagram of a main operation of the hair clippers of FIG. 1;

FIG. 4 illustrates an exemplary block diagram of supporting interrupts of the hair clippers of FIG. 1;

FIG. 5 illustrates an exemplary block diagram of a time scheduler operation of the hair clippers of FIG. 1;

FIG. 6 illustrates an exemplary block diagram of a HAL task operation of the hair clippers of FIG. 1;

FIG. 7 illustrates an exemplary block diagram of a speed selection operation of the hair clippers of FIG. 1;

FIG. 8 illustrates an exemplary block diagram of a speed control operation of the hair clippers of FIG. 1;

FIG. 9 illustrates an exemplary block diagram of a determine idle operation of the hair clippers of FIG. 1; and

FIG. 10 illustrates an exemplary block diagram of a LEDs operation of the hair clippers of FIG. 1.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE INVENTION

While this invention is susceptible of embodiments in many different forms, there are shown in the drawings and will be described in detail herein specific embodiments with the understanding that the present disclosure is an exemplification of the principles of the invention. It is not intended to limit the invention to the specific illustrated embodiments. The features disclosed herein in the description, drawings, and claims can be significant, both individually and in any desired combinations, for the operation of the invention in its various embodiments. Features from one embodiment can be used in other embodiments of the invention.

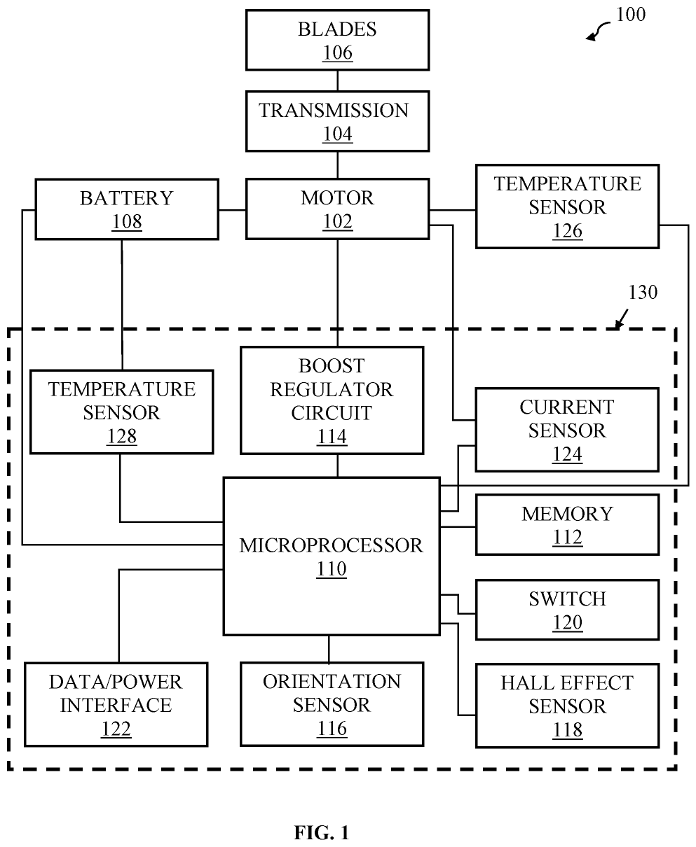

Referring to the drawings, FIG. 1 illustrates a block diagram of clippers 100 that may be used to clip hair of a person or pet. The clippers 100 operate in a manner substantially known and understood in the art that is similar to clippers that are currently on the market. However, unlike clippers that are currently on the market, the clippers 100 include a controller (e.g., microprocessor, etc.), such as one mounted on a printed circuit board assembly (PCBA), and one or more sensors to control operating parameters (e.g., speed, current, voltage, etc.) of the hair clippers battery, motor, and blades and a communication and/or power connection (e.g., a universal serial bus (USB) interface, etc.) that enables the operating parameters to be changed, controlled, and/or downloaded from and/or to a computing device (e.g., a personal computer (PC), etc.). These features of clippers 100 enables the clippers to record parameters (e.g., voltage, current, temperature, etc.) and transfer/download them to a computing device, increase battery life and usage time of the clippers, reduce charging time of the battery, better control the blade speed, and provide overheating protection for the motor and blades.

The clippers 100 include a motor 102, a transmission 104, blades 106, a battery 108, a microprocessor 110, a memory 112, a boost regulator circuit 114, an orientation sensor 116, a Hall effect sensor 118, a switch 120, a data/power connection interface 122, a current sensor 124, and one or more temperature sensors 126, 128. In some embodiments, one or more of the components of the clippers 100 may be mounted on a printed circuit board assembly (PCBA) 130.

The motor 102 is operable to drive the blades 106 via the transmission 104. For example, the transmission 104 may convert rotational motion of the motor 102 into lateral motion of the blades 106. In some embodiments, this may be accomplished by use of an eccentric, though other structures are envisioned as would be understood. The motion of the blades 106 relative to one another, or the motion of one blade 106 relative to another blade 106, provides the cutting mechanism for the clippers 100. The battery 108 is operable to supply electric power to the motor 102, the microprocessor 110, and/or other components of the clippers 100. In some embodiments, the clippers 100 may not include a battery, and may instead include an integrated power cord.

The microprocessor 110 is operable to receive input data (e.g., from orientation sensor 116, Hall effect sensor 118, switch 120, data/power connection interface 122, etc.), process the input data according to instructions stored in its memory (e.g., a non-transitory computer readable storage medium comprising the microprocessor 110, the memory 112, etc.), and provide output data and control signals (e.g., to boost regulator circuit 114, motor 102, memory 112, data/power connection interface 122, etc.). In some embodiments, the microprocessor 110 is operable to execute instructions for determining when the blades 106 are cutting hair compared to not cutting hair. For example, the microprocessor 110 may make the determination based on current consumption and power of the motor 102. The microprocessor 110 is operable to execute instructions for operating the motor 102 at a cutting speed (e.g., 3600 RPM, etc.) in response to determining that the blades 106 are cutting hair. The microprocessor 110 is also operable to control the motor 102 down to an idle speed (e.g., 3400 RPM, etc.) in response to determining the blades 106 are not cutting hair. In some embodiments, the microprocessor 110 is operable to execute instructions for measuring an amount of time between pulses received from the motor 102 and converting the amount of time into a speed of the motor 102. In some embodiments, the microprocessor 110 measures the pulses for exactly one pulse width modulation (PWM) period.

The memory 112 is operable to store the processor-executable instructions described herein and/or data for operating parameter values of the clippers 100. Exemplary memory devices include, but are not limited to, random-access memory (RAM) (e.g., dynamic random-access memory (DRAM), static random-access memory (SRAM), etc.), read-only memory (ROM) (e.g., programmable read-only memory (PROM), electrically erasable programmable read-only memory (EEPROM), flash memory, etc.), hard disk drives, solid-state drives, or the like and combinations thereof. Although illustrated as a separate component in FIG. 1, those skilled in the art will understand that the memory 112 can be combined with the microprocessor 110 in some embodiments. In other embodiments, multiple memories and/or multiple microprocessors can be used.

The boost regulator circuit 114 is operable to maintain the value of the available motor voltage. For example, the boost regulator circuit 114 may be operable to maintain a voltage of the motor 102 at a value greater than or equal to 3.8 Volts DC.

The orientation sensor 116 is operable to measure the orientation and/or motion of the clippers 100 and provide data values of the measurements. An exemplary orientation sensor includes, but is not limited to, an accelerometer. In some embodiments, the microprocessor 110 is operable to execute instructions for determining when the blades 106 are cutting hair compared to not cutting hair based on values received from the orientation sensor 116. The microprocessor 110 is operable to execute instructions for operating the motor 102 at a cutting speed (e.g., 3600 RPM, etc.) in response to determining the blades 106 are cutting hair (i.e., not oriented in a flat position) and for operating the motor 102 at an idle speed (e.g., 3400 RPM, etc.) in response to determining the blades 106 are not cutting hair (i.e., when the clippers 100 are flat for a period of time). In other embodiments, the microprocessor 110 is operable to execute instructions for determining when the hair clippers are in a user's hand by monitoring orientation and motion of the clippers 100 based on values received from the orientation sensor 116.

The Hall effect sensor 118 is operable to measure the magnitude of a magnetic field. For example, the Hall effect sensor 118 may measure the magnetic field of a magnetized polymer disk on a shaft of the motor 102.

The switch 120 is operable by a user to control operation of the motor 102 and blades 106.

The data/power connection interface 122 is operable to transfer data and/or power between the microprocessor 110 and an external computing device, such as a personal computer (PC), a laptop computer, a tablet, a smartphone, or the like. In some embodiments, the microprocessor 110 is operable to execute instructions for storing received data values in the memory 112 and transferring the stored values to a computing device via the data/power connection interface 122.

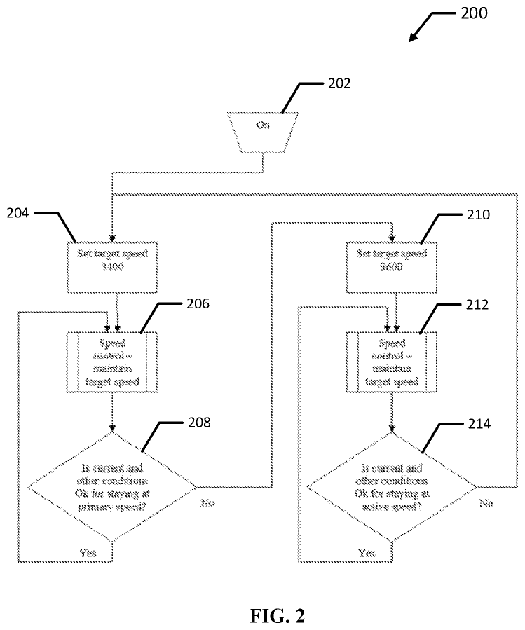

FIG. 2 illustrates a simplified block diagram of an exemplary method 200 of operation of the clippers 100. At 202, the clippers 100 are turned on. For example, a user may select the switch 120 to activate components of the clippers 100 (e.g., the motor 102, the blades 106, the battery 108, the microprocessor 110, etc.). At 204, the microprocessor 110 sets the target speed of the motor 102 to 3400 revolutions per minute (RPM). In an embodiment, this may be referred to as an “idle speed” of the motor 102.

At 206, the microprocessor 110 maintains the target speed of 3400 RPM. In an embodiment, the microprocessor 110 determines the speed of the motor 102 as follows. As the motor 102 rotates, it provides a fixed number of pulses to the microprocessor 110 per single rotation as measured by Hall effect sensor 118. The microprocessor 110 measures the amount of time between pulses and converts this to speed (i.e., RPMs). This provides 1 RPM resolution and also provides an updated speed measurement every rotation of the motor 102. These accurate and frequent speed measurements enable the microprocessor 110 to maintain the target speed.

At 208, the microprocessor 110 determines whether the operating parameters (e.g., speed, current, voltage) of clippers indicate the speed set at 204 (e.g., the idle speed, 3400 RPMs, etc.) should be maintained. When the microprocessor 110 determines that the operating parameters indicate that the speed should be maintained, the method 200 reverts to step 206. When the microprocessor 110 determines that the operating parameters indicate that the speed should be altered, the method 200 continues to step 210. In an embodiment, the microprocessor 110 determines when the blades 106 are cutting hair compared to not cutting hair by monitoring current consumption of the motor 102 and the power of the motor 102. Not cutting hair is considered idle. When the clippers 100 is idle, the microprocessor 110 operates to control the motor 102 and the blades 106 at idle speed. Idle speed is lower than the speed used for cutting and therefore reduces noise, vibration, motor heat, blade heat, and wear, all while increasing battery life. The measurement of motor current is not burdened by being required to be synchronized to the pulse width modulation (PWM) signal providing power to the motor 102. Because the PWM signal perfectly repeats every PWM period, the current measurement operation of the microprocessor 110 takes advantage of this and begins randomly anywhere in the PWM pulse stream. This is possible because the measurement lasts for exactly one PWM period.

Additionally or alternatively, the microprocessor 110 determines when the blades 106 are cutting hair compared to not cutting hair by monitoring motion of the clippers 100. For example, the microprocessor 110 may use feedback from the orientation sensor 116 (such as an accelerometer, etc.) to monitor motion. Not cutting hair is considered idle. When the clippers 100 are in an idle state, the microprocessor 110 operates to control the motor 102 and the blades 106 at idle speed. Idle speed is lower than the speed used for cutting and therefore reduces noise, vibration, motor heat, blade heat, and wear, all while increasing battery life. In an embodiment, the microprocessor 110 determines when the clippers 100 is in a user's (e.g., barber's, etc.) hand compared to being stored by monitoring orientation and motion of the clippers 100. For example, the microprocessor 110 may monitor orientation and motion of the clippers 100 for a period of time (e.g., about 2 seconds, etc.). When the microprocessor 110 determines, based on the input from the orientation sensor 116, that the clippers 100 is either vertical or horizontal with no motion the microprocessor 110 considers the clippers 100 to be in a stored state. Otherwise, the microprocessor considers the clippers 100 to be in a usage state. When the microprocessor 110 considers the clippers 100 to be in the stored state, it controls the motor 102, blades 106, and battery 108 to turn the clippers 100 off. When picked up by the user (e.g., when the orientation is no longer either vertical or horizontal with no motion) the microprocessor 110 considers the clippers 100 to be in the usage state and controls the motor 102, blades 106, and battery 108 to turn the clippers 100 on. In some embodiments, the microprocessor 110 records (e.g., in memory 112, etc.) x-axis, y-axis, and z-axis orientation data of the clippers 100 and the change in x-axis values, y-axis values, and z-axis values along with time to enable tracking the clippers 100 in space. For example, this may allow the study of cutting styles, duration, efficiency, and how the clippers are serving users (e.g., barbers) in general.

At 210, the microprocessor 110 sets the target speed of the motor 102 to 3600 RPMs. In an embodiment, this may be referred to as a “cutting speed” of the motor 102.

At 212, the microprocessor 110 maintains the target speed of 3600 RPM. In an embodiment, the microprocessor 110 determines the speed of the motor 102 as described above.

At 214, the microprocessor 110 determines whether the operating parameters (e.g., speed, current, voltage) of clippers 100 indicate the speed set at 210 (e.g., the cutting speed, 3600 RPMs, etc.) should be maintained. When the microprocessor 110 determines that the operating parameters indicate that the speed should be maintained, the method 200 reverts to step 210. When the microprocessor 110 determines that the operating parameters indicate that the speed should be altered, the method 200 reverts to step 204. The microprocessor 110 determines the operating parameters of clippers 100 as described above.

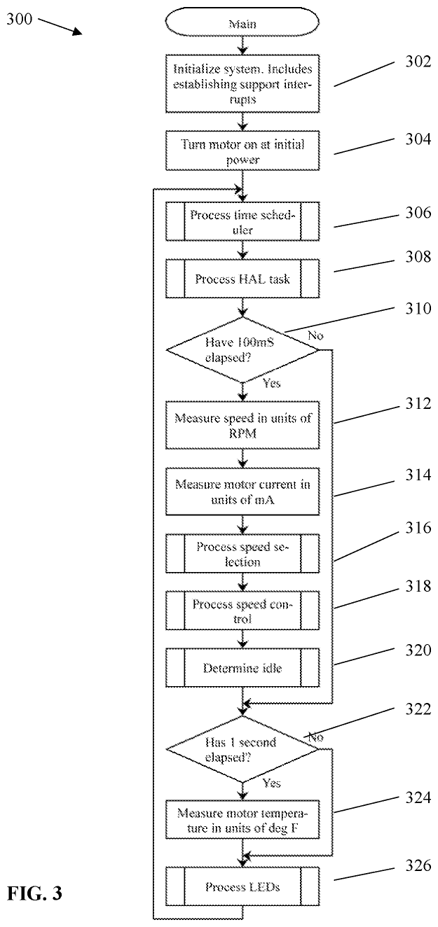

FIGS. 3-10 illustrate more detailed block diagrams of operation of the clippers 100. Referring to FIG. 3, a main operation 300 will first be described below.

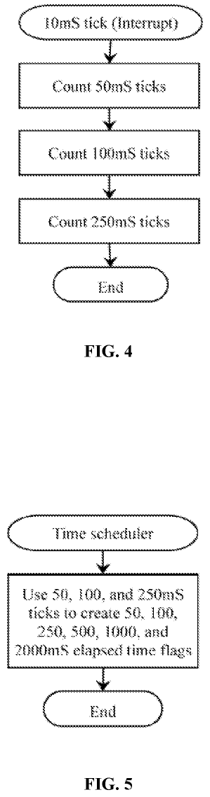

When the clippers 100 are first turned on, at 302, the microprocessor 110 initializes the system for the clippers 100, which includes establishing support interrupts. FIG. 4 illustrates an exemplary block diagram of supporting interrupts. Specifically, the microprocessor 110 can be configured to count clock ticks in order to determine a time interval. As shown in FIG. 4, the microprocessor 110 can be configured to count 10 mS (milliseconds), 50 mS, 100 mS, or 250 mS, though the microprocessor 110 can be configured to count other time intervals using the same principal.

At 304, the motor 102 can be turned on at an initial power which can be predetermined at a factory. For example, the initial power can be a percentage of maximum available power for the clippers 100. In an embodiment, the initial power can be between sixty percent (60%) to one hundred percent (100%) of the maximum available power. More particularly, the initial power can be between seventy percent (70%) to eighty percent (80%) of the maximum available power. In a specific embodiment, the initial power can be about seventy-eight percent (78%) of the maximum available power.

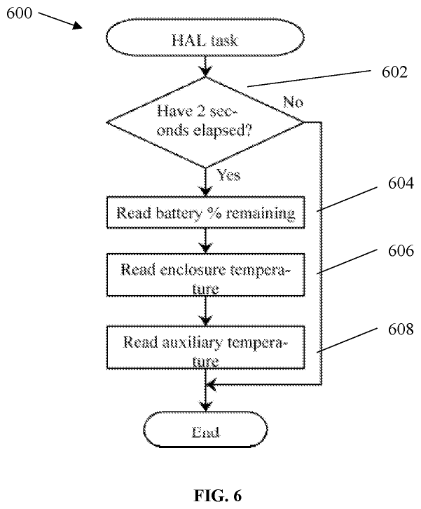

At 306, the microprocessor 110 processes a time scheduler operation, which is shown in more details in FIG. 5. By using 50 mS, 100 mS, and 250 mS ticks as described above, the microprocessor 110 can be configured to create elapsed time flags that correspond to 50 mS, 100 mS, 250 mS, 500 mS, 1,000 mS, and 2,000 mS. Additional elapsed time flags may also be created if called for depending on the specific implementation of the clippers 100.

At 308, the microprocessor 110 processes a HAL task operation 600, which is shown in more details in FIG. 6.

Referring to FIG. 6, at 602, using the elapsed time flags, the microprocessor 110 can be configured to determine whether a first time interval (such as 2 seconds) has elapsed. If the first time interval has not elapse, then the HAL task operation 600 ends and the microprocessor 110 continues the main operation 300 at 310.

If the first time interval has elapsed, at 604, can be configured to read a remaining percentage of the battery 108. As voltage decreases throughout usage of the battery 108, remaining percentage of the battery 108 can be read by either monitoring and measuring the voltage of the battery 108, or by monitoring and measuring the current discharged by the battery 108. Of course, other methods to read the remaining percentage of the battery 108 can also be implemented.

At 606, the microprocessor 110 can be configured to read an enclosure temperature, and at 608, the microprocessor 110 can be configured to read an auxiliary temperature. For example, referencing FIG. 1, a motor housing can contain the temperature sensor 126 which can be used to detect a temperature of the motor 102 which is then read by the microprocessor 110. Further, another temperature sensor 128 can be used to detect a temperature of the battery 108 which is then read by the microprocessor 110. In some embodiments, the temperature sensor 128 can be in the microprocessor 110. Certainly, more or less temperature sensors can also be utilized to realize steps 606 and 608.

Thereafter, the HAL task operation 600 ends and the microprocessor 110 continues the main operation 300 at 310.

Returning to FIG. 3, at 310, the microprocessor 110 determines whether a second time interval has elapsed (such as 100 mS). If the second time interval has not elapsed, then the microprocessor 110 can be configured to skip to 322 that will be described later. If the second time interval has elapsed, at 312, the microprocessor 110 can be configured to measure speed of motor 102 in RPM (revolution per minute). At 314, the microprocessor 110 can be configured to measure a current through the motor 102 via the current sensor 124 or other appropriate means in an appropriate unit such as milliamp (mA). In an embodiment, the current sensor 124 (with reference to FIG. 1) can be on a negative leg on the PCBA 130.

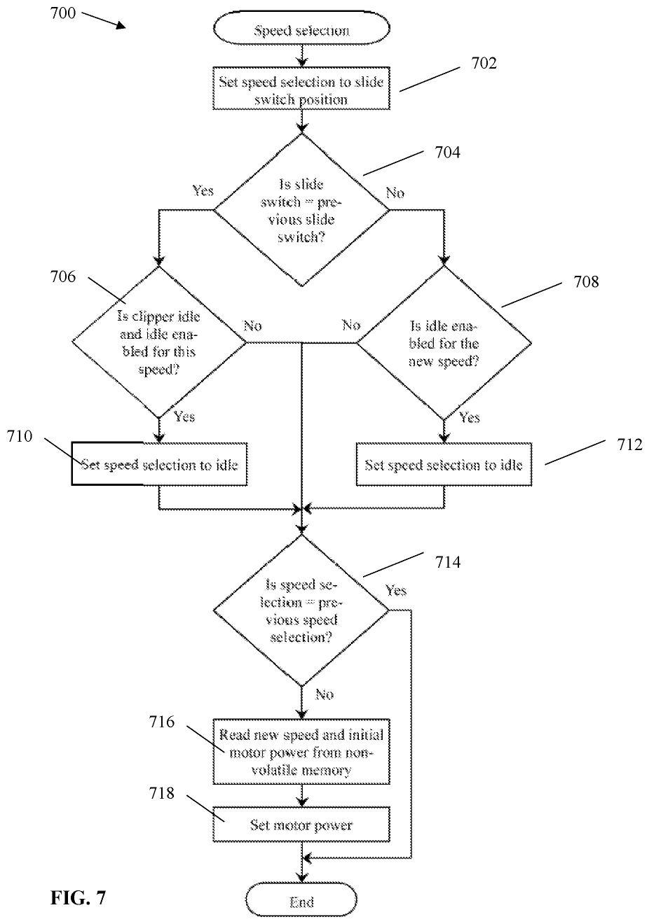

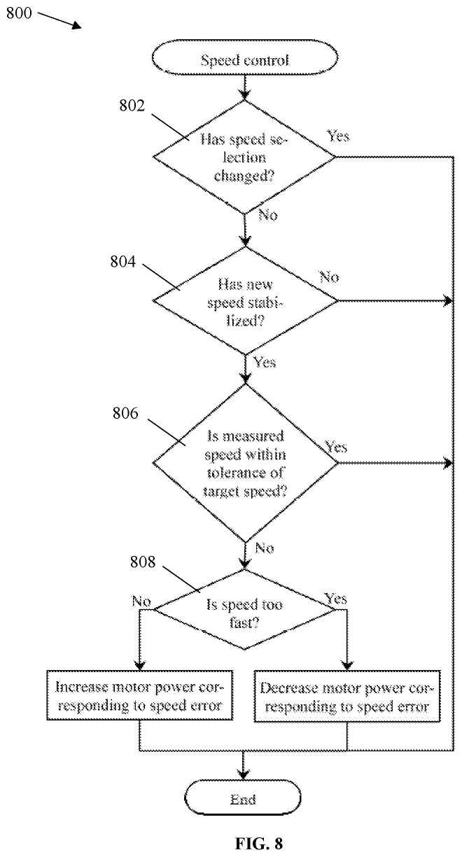

At 316, the microprocessor 110 processes speed selection operation 700, which is shown in more details in FIG. 7.

Referring to FIG. 7, at 702, a user can set a speed selection by manipulating a speed switch, such as sliding a slide switch to a position that corresponds to a desired speed of the motor 102. It is to be understood that speed selection is not limited to using a slide switch. For example, buttons, toggles, touch screens, or other appropriate user interfaces can also be used for speed selection by the user.

At 704, the microprocessor 110 can be configured to determine whether the current speed switch position is the same as a previous speed switch position. If the current speed switch position is the same as a previous speed switch position, at 706, the microprocessor 110 is further configured to determine whether the clippers 100 is idle and idle enable at a current speed. If the current speed can be set as idle speed, then at 710, the microprocessor 110 sets the current speed as the idle speed. If not, then the operation moves to 714. The idle speed can either be predetermined during production at a factory, or in some embodiments, it can be set after purchase. By way of example, the idle speed can be around 2,800 to 3600 RPM. In an embodiment, the idle speed can be set at 2,800, 2,900, or 3,000 RPM.

Returning to 704, if the current speed switch position is not the same as the previous speed switch position, at 708, the microprocessor 110 can be configured to determine whether the clippers 100 is idle enabled for a new speed that corresponds to the current speed switch position. If the clippers 100 is idle enabled for the new speed, then at 712, the microprocessor 110 sets the new speed as the idle speed. If not, then the operation moves to 714.

At 714, the microprocessor 110 can be configured to determine whether a current speed selection is the same as a previous speed selection. If it is, then the speed selection operation 700 ends and the microprocessor 110 continues the main operation 300 at 318. However, if the current speed selection is not the same as the previous speed selection, a new speed needs to be set. At 716, the microprocessor 110 can be configured to read the new speed and initial power of the motor 102 from the memory 112. In an embodiment, the memory 112 can store a plurality of speed settings, thus when a new speed is selected, the microprocessor 110 can read the memory 112 to determine the speed that corresponds to the selection. In a simplified example, the memory 112 can contain two speed settings, one for high speed and one for low speed that can be set at the factory. When the speed selection changes, the microprocessor 110 can read the memory 112 to determine the appropriate speed. Moreover, due to blade friction, cutting, and other potential issues that can cause the speed to change, the microprocessor 110 can also read the memory 112 for the right speed and bring the speed back to its correct setting. Thereafter, the microprocessor 110 can be configured to set the power to the motor 102 to correspond to the current speed selection. Specifically, by increasing or decreasing the power to the motor 102, the speed of the motor 102 can be increased or decreased respectively. Then, the speed selection operation 700 ends and the microprocessor 110 continues the main operation 300 at 318.

At 318, the microprocessor 110 processes speed control operation 800, which is shown in more details in FIG. 8.

Referring to FIG. 8, at 802, the microprocessor 110 can be configured to determine whether speed selection has changed. If the speed selection has changed, the speed control operation 800 ends and the microprocessor 110 continues the main operation 300 at 320.

If the speed selection has not change, at 804, the microprocessor 110 can be configured to determine whether the new speed selected at speed selection operation 700 has stabilized. By way of example, when the motor 102 needs to increase its speed from 2600 RPM to 3600 RPM, the increase would not be instantaneous. Thus, it can be said that a new speed has stabilized when acceleration is below a certain threshold. Such threshold can be predetermined, or it can be set via user input. In another embodiment, the new speed can be determined to have been stabilized when the speed is plus or minus a certain threshold. For example, if a target speed is 3600 RPM, then the new speed can be determined as having been stabilized when the speed is within plus or minus 30 RPM from the target speed. If the new speed has not stabilized, the speed control operation 800 ends and the microprocessor 110 continues the main operation 300 at 320.

If the new speed has stabilized, the microprocessor 110 is further configured to determine whether the measured speed is within tolerance of a target speed. Such tolerance can be predetermined or set by a user. By way of example, an acceptable tolerance can be plus or minus ten percent (10%) of the target speed. If the measured speed is within tolerance of the target speed, the speed control operation 800 ends and the microprocessor 110 continues the main operation 300 at 320.

If the measured speed is outside of tolerance of the target speed, at 808, the microprocessor 110 can be configured whether the measured speed is too fast (or too slow) by comparing the measured speed to the target speed. If the measured speed is too fast, the microprocessor 110 can be configured to decrease motor power corresponding to such speed error. If the measured speed is too slow, the microprocessor 110 can be configured to increase motor power corresponding to such speed error. Thereafter, the speed control operation 800 ends and the microprocessor 110 continues the main operation 300 at 320.

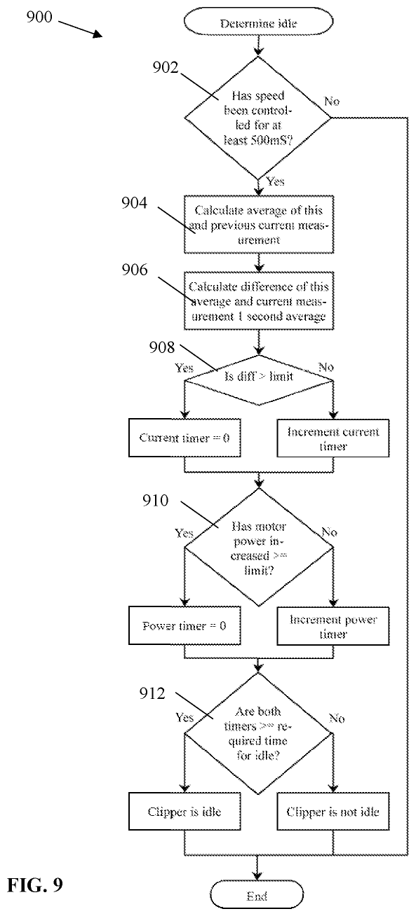

At 320, the microprocessor 110 processes determine idle operation 900, which is shown in more details in FIG. 9.

At 902, the microprocessor 110 can be configured to determine whether motor speed has been control-led (such as controlled by speed control operation 800) for at least a third time interval (such as 500 mS). If not, the determine idle operation 900 ends and the microprocessor 110 continues the main operation 300 at 322.

If the motor speed has been control-led for at least the third time interval, then at 904, the microprocessor 110 can be configured to calculate a first average current between a present and a previous current measurement. At 906, the microprocessor 110 can be configured to calculate a difference between the first average current and a second average current, which is an average current measured over a fourth time interval (such as 1 second).

At 908, the microprocessor 110 can be configured to determine whether the difference calculated at 906 is larger than a first limit. In an example, the first limit can be between ten to thirty milliampere (mA), and more precisely, between twelve to fifteen mA. Such first limit can be predetermined during production. If the difference is larger than the limit, then the microprocessor 110 can be configured to reset a current timer to zero. If not, then then the microprocessor 110 can be configured to increase the current timer incrementally.

At 910, the microprocessor 110 can be configured to determine whether the motor power has increased beyond a second limit. In an example, the second limit can be between one to five, and more precisely, the second limit can be set at factory to one (unitless number). If so, the microprocessor 110 can be configured to reset a power timer to zero. If not, then the microprocessor 110 can be configured to increase the power timer incrementally.

At 912, the microprocessor 110 can be configured to determine whether both the current timer and the power timer exceeded or equal to a required time for idle. In an example, the required time for idle can be between one to five, and more precisely between one to three. If so, the microprocessor 110 determines that clippers 100 is idle. If not, the microprocessor 110 determines that clippers 100 is not idle. Thereafter, the determine idle operation 900 ends and the microprocessor 110 continues the main operation 300 at 322.

Referring back to FIG. 3, at 322, the microprocessor 110 determines whether a fifth time interval has elapsed (such as 1 second). If the fifth time interval has not elapse, then the microprocessor 110 can be configured to skip to 326 that will be described later. If the fifth time interval has elapsed, at 324, the microprocessor 110 can be configured to measure temperature of motor 102 before proceeding to 326.

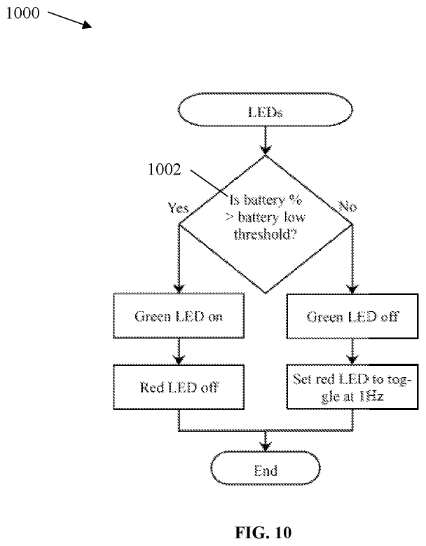

At 326, the microprocessor 110 processes LEDs operation 1000, which is shown in more details in FIG. 10.

Referring to FIG. 10, at 1002, the microprocessor 110 can be configured to determine whether the remaining percentage of the battery 108 is greater than a battery low threshold. Such battery low threshold can be a predetermined value such as when the remaining percentage of the battery 108 drops below twenty percent (20%) or ten percent (10%). As explained above, the remaining percentage of the battery 108 can be determined by either monitoring and measuring the voltage of the battery 108, or by monitoring and measuring the current discharged by the battery 108.

If the remaining percentage of the battery 108 is greater than the battery low threshold, the microprocessor 110 can be configured to turn and keep a first indicator on (such as a green LED). The microprocessor 110 can also be configured to turn and keep a second indicator off (such as a red LED).

On the other hand, if the remaining percentage of the battery 108 is lower than the battery low threshold, the microprocessor 110 can be configured to turn and keep the first indicator off, while turning and keeping the second indicator on or toggling the second indicator on and off at a specific frequency such as 1 hertz (Hz).

Referring back to FIG. 3, after the microprocessor 110 is done processing the LEDs operation 1000 at 326, the microprocessor 110 can be configured to continues the main operation 300 by looping back to 306.

In an embodiment, the presence of the boost circuitry allows a consistent, higher supply voltage to be available to the motor 102 regardless of the terminal voltage of the battery 108. This, in turn, provides higher, consistent power to the motor 102 and shear drive assembly in addition to the 3.3 Volt power supply without problems caused by falling battery terminal voltage. Voltage of the battery 108 decreases as clippers on-time increases. Consistent powerful motor operation is best achieved with consistent substantial voltage available to the motor 102. In an embodiment, the boost regulator circuit 114 enables the clippers 100 to maintain an available motor voltage. For example, the boost regulator circuit 114 may maintain an available motor voltage greater than or equal to 3.8 Volts direct current (DC).

In an embodiment, a magnetized polymer disk is included on the shaft of motor 102 proximate to the PCB sensor position. The Hall effect sensor 118 may be embodied as an integrated circuit (IC). The sensor IC contains a Hall cell and signal conditioning circuitry to provide logic-level output indicating proximity of magnetic north pole of the magnet relative to the sensor. The pulse train frequency is proportional to the motor speed in RPM. The output of the Hall effect sensor 118 is applied directly to one or more inputs of the microprocessor 110.

It will become apparent to those skilled in the art that aspects of the invention may be able to record operating parameter (e.g., voltage, current, temperature, etc.) values of the clippers and transfer the data values to computing devices, increase battery life and usage time of the clippers, reduce battery charging time, better control blade speed, and provide overheating protection for the motor and blades. In some aspects, a microprocessor the clippers determines when the clippers are cutting hair compared to not cutting hair (i.e., “idle”). In other aspects, the clippers include a boost regulator circuit to achieve battery voltage that decreases as clippers on-time increases. In further aspects, the microprocessor determines when the clippers are in a user's hand compared to being stored by monitoring orientation and motion of the clippers and will control operation of the motor and blades accordingly. In other aspects, the microprocessor records and stores positions of the clippers during use to allow the study of cutting styles, duration, efficiency, and how the clippers are serving users (e.g., barbers) in general. In further aspects, the clippers include a feedback control circuit that is controlled through a PWM signal that perfectly repeats exactly one PWM measurement at a time.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.”

Specific embodiments of a guidance apparatus for an assembly system according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. It is understood to encompass the present invention and any and all modifications, variations, or equivalents that fall within the spirit and scope of the basic underlying principles disclosed and claimed herein.

What is claimed is:

1. A hair clippers device, comprising:
a motor;
one or more blades coupled to the motor;
a sensor; and
a microprocessor coupled to the sensor,
wherein the microprocessor is operable to change a speed of the motor based on inputs of the sensor.

2. The hair clippers device of claim 1, wherein the sensor is an accelerometer.

3. The hair clippers device of claim 1, wherein the microprocessor is further configured to change the speed of the motor based a current consumption of the motor.

4. The hair clippers device of claim 3, wherein the microprocessor is further configured to determine that the hair clippers device is in an idle state, a stored state, or a usage state.

5. The hair clippers device of claim 4, wherein the microprocessor is further configured to reduce the speed of the motor when the hair clippers device is determined to be in the idle state.

6. The hair clippers device of claim 4, wherein the microprocessor is further configured to turn off the motor when the hair clippers device is determined to be in the stored state.

7. The hair clippers device of claim 4, wherein the microprocessor is further configured to turn on the motor when the hair clippers device is determined to be in the usage state.

8. The hair clippers device of claim 1, wherein the microprocessor is further configured to change the speed of the motor based a measurement of time.

9. The hair clippers device of claim 4, wherein the microprocessor is further configured to determine that the hair clippers device is in the stored state when the hair clippers device is in a horizontal orientation with no motion for more than a first time interval.

10. The hair clippers device of claim 4, wherein the microprocessor is further configured to determine that the hair clippers device is in the idle state based on current consumption and a motor power.

11. The hair clippers device of claim 10, the microprocessor is further configured to:
calculate a first average current over a second time interval and a second average current over a third time interval;
reset a current timer when a difference between the first average current and the second average current exceeds a first limit; and
increase the current timer when the difference between the first average current and the second average current does not exceed the first limit,
wherein the idle state is determined when the current timer exceeds or equals to an idle time.

12. The hair clippers device of claim 11, the microprocessor is further configured to:
reset a power timer when the motor power exceeds a third limit; and
increase the power timer when the motor power does not exceed the third limit,
wherein the idle state is determined when the current timer and the power timer exceed or equal to the idle time.

13. The hair clippers device of claim 4, wherein the microprocessor is further configured to determine that the hair clippers device is in the usage state based on the sensor detecting motion.
